(19) United States
(12) Patent Application Publication
(10) Pub. No.: US 2003/0017293 A1
(43) Pub. Date: Jan. 23, 2003

(54) Deformation-resistant in-mold labels and method of manufacture thereof

(76) Inventors: Joseph D. Franko SR., Ham Lake, MN (US); Todd C. Wentz, Rogers, MN (US)

Correspondence Address: WALTER K. ROLOFF, 490 HARBOR COURT, SHOREVIEW, MN, 55126, US

(21) Appl. No.: 09/909,479

(22) Filed: Jul. 23, 2001

(51) Int. Cl. B32B 7/06

(52) U.S. Cl. 428/41.8; 283/81

(57) ABSTRACT

A deformation-resistant in-mold label includes a base ply, suitable for an in-mold labeling process, having a printable top surface and a bottom surface. A release coating is applied over a selected portion of the top surface of the base ply. An adhesive coating is applied over at least a selected portion of the release coating. A top ply, suitable for an in-mold labeling process, is adhesively joined to a portion of the base ply by the adhesive coating. The top ply exhibits dimensional shrinking, in response to in-mold process temperatures, in a range from 0% to 5%.

### FIELD OF THE INVENTION

The present invention relates generally to labels. The invention relates specifically to extended text labels for in-mold processes, that are resistant to deformation.

### BACKGROUND OF THE INVENTION

In the printing arts, and in particular in the commercial printed label art for labeling and decorating consumer products, there exists a continual demand for labels and decorations which not only appeal to consumers, but also bear ever increasing amounts of printed information. For example, labels for identification of consumer health care and pharmaceutical products are often required by governmental regulations to describe in painstaking detail their compositions and ingredients. As new food and drug laws are passed, regulations require the inclusion of increasing amounts of label information.

To provide increased printed information on labels, various forms of socalled “extended text” labels have been proposed. One such extended text label type that has gained wide popularity is the booklet type label, where a base ply is joined to a top ply via an adhesive coupling or “hinge” between the two plies. An example of this type of label is disclosed in U.S. Pat. No. 5,264,265 issued to Kaufmann, entitled “PEEL-BACK RE-SEALABLE MULTI-PLY LABEL”.

Extended text labels are desired for a virtually limitless range of applications in consumer product containers and packaging. A container or package that has gained wide popularity is produced in a so-called “in mold” labeling process. In an in-mold labeling process, a label is commonly provided having a heat activated adhesive coating on one of its faces. The label is placed against a wall of one of two chilled mold cavities in a so-called “blow molding machine”, with its heat activated adhesive coating face oriented inwardly and its opposite face held against the chilled cavity wall by means of vacuum suction. The mold is closed over a tube of molten plastic having a temperature of about 300°-500° F. Air is then forced, under pressure, into the mold, thereby pushing the molten plastic against the chilled cavity walls and creating a container having a shape according to a design of the mold. Concurrently, the molten plastic contacts the heat activated adhesive coating of the label, whereby the label becomes integrally bonded to the container so formed.

As used herein, an “in-mold labeling process” may include any so-called “blow mold” or “injection mold” techniques, along with any other analogous processes. Common in-mold labeling processes, utilizing HDPE (high density polyethylene) and PET (polyethylene terephthalate) plastics, are provided by, for example, Owens-Illinois, Inc., of Perrysburg, Ohio. In-mold labeling processes are desirable because of their provision of a “pre-decorated” container to a customer, and because they are thought to use less plastic material in their construction relative to conventional plastic containers, due to the in-mold label being integral with the container.

One label type for in-mold labeling processes that has been developed is the so-called coupon-type in-mold label as disclosed in U.S. Pat. No. 5,172,936 issued to Sullivan, et al., entitled “IN-MOLD LABEL HAVING A REMOVABLE COUPON PORTION” and U.S. Pat. No. 5,238,720 issued to Volkman, entitled “MOLDED-IN LABEL WITH REMOVABLE PORTION.” In these patents, where the labels are typically paper based, deformation may occur because of relative structural weight and density differences between a given container and its integral in-mold paper based label. Specifically, a light gram weight container, relative to a paper based label for the container, may lead to a deformation known as “panel bulge” in the label. The undesirable panel bulge results from the paper based label resisting shrinking or physical change in the in-mold label process, while a relatively light gram weight container fabricated in the process is not as resistant to such change. Thus, to overcome panel bulge, a heavier weight container (e.g., 11 grams) must be fabricated in the in-mold label process.

Aside from the aforementioned paper based coupon-type in-mold labels, booklet type extended text labels have not heretofore been successfully integrated with in-mold labeling processes. This is due in large part to deformation (e.g., wrinkling or buckling) of the top ply. The deformation results from temperature variations between the container created by the in-mold process coupled with the integral base ply (about 150° to 200° F.), and the top ply being held against the chilled cavity wall and therefore being substantially cooler than the container/base ply combination. Thus, as the container and integral base ply cool from the typical 150° to 200° F. range, they shrink in their overall dimensions; the top ply, however, being substantially cooler than the container/base ply, does not undergo a similar dimensional shrinkage.

Therefore, there exists a need for a coupon-type label that resists panel bulge in an in-mold process. There also exists a need for a booklet type label that is resistant to deformation in an in-mold process.

It is generally accepted and well-known in the label making arts that in-line printing and converting processes offer the most cost-effective label production. An exemplary in-line method is disclosed in U.S. Pat. No. 4,849,043 issued to Instance, entitled “METHOD OF PRODUCING LABELS”.

Therefore, there additionally exists a need for an in-line converting and printing process for manufacture of such labels suitable to the aforedescribed in-mold processes.

### SUMMARY OF THE INVENTION

An object of the present invention is to provide an in-mold label that is inexpensive and simple to produce.

Another object of the present invention is to provide an extended text or booklet-type in-mold label that is resistant to deformation in an in-mold container fabrication process.

Yet another object of the present invention is to provide a coupon-type in-mold label that is resistant to deformation in an in-mold container fabrication process.

A further object of the present invention is to provide an in-line converting and printing process for manufacture such labels.

In accordance with the present invention, a deformation-resistant in-mold label includes a base ply, suitable for an in-mold labeling process, having a printable top surface and a bottom surface. A release coating is applied over a selected portion of the top surface of the base ply. An adhesive coating is applied over at least a selected portion of the release coating. A top ply is adhesively joined to a portion of the base ply by the adhesive coating. The top ply exhibits dimensional shrinking, in response to in-mold process temperatures, in a range from 0% to 5%.

### BRIEF DESCRIPTION OF THE DRAWINGS

FIG. 1 is an illustration of an exemplary deformation-resistant in-mold label, constructed in accordance with the present invention and shown as having been secured to a container in an in-mold process.

FIG. 2 is a schematic side view representation of the label of FIG. 1.

FIG. 3 is a magnified illustration of components of an alternative embodiment of the label of the present invention.

FIG. 4 is a schematic diagram of a manufacturing method for production of a label of the present invention.

FIG. 5 is an overhead view of a web of labels as individually shown in FIG. 1, produced in the method of FIG. 4.

### DETAILED DESCRIPTION OF THE INVENTION

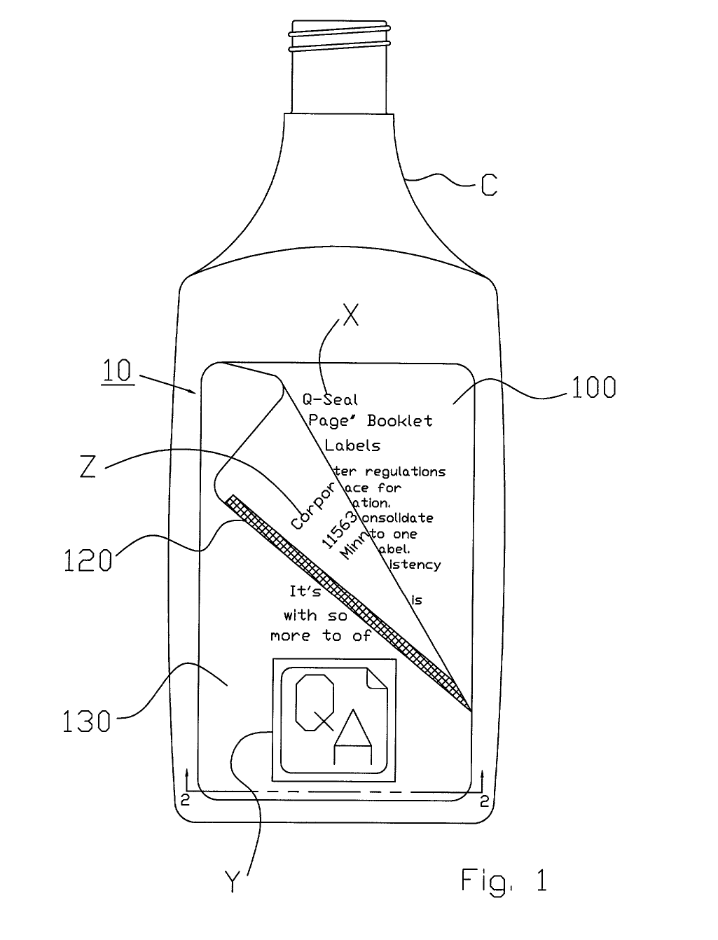

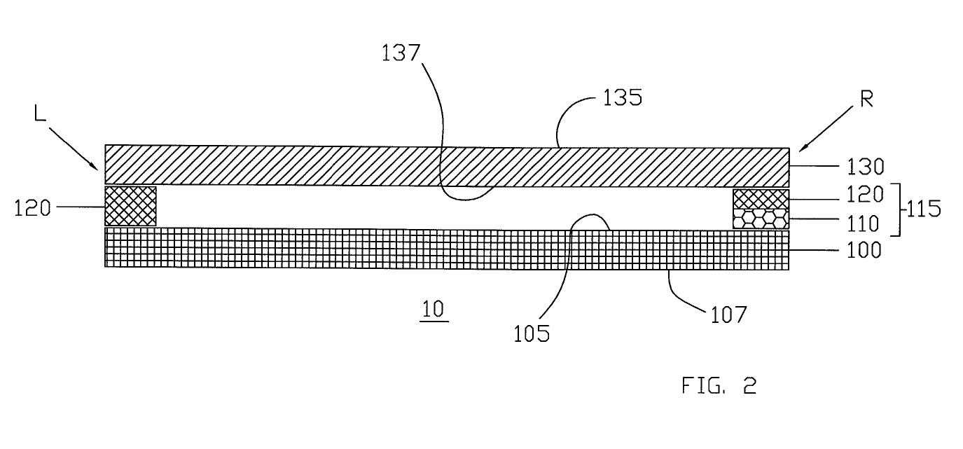

Referring to FIGS. 1 and 2, there shown are in-use and cross-sectional views, respectively, of a deformation-resistant in-mold label 10. Specifically, in FIG. 1, label 10 is depicted as having been adhered, in an in-mold labeling process such as aforedescribed, to a container C; in FIG. 2, label 10 is shown in cross-sectional schematic fashion, as viewed along reference line 2-2 in FIG. 1, so that spatial relationships between components thereof may be readily ascertained.

In FIGS. 1 and 2, label 10 includes a base ply 100 having a top surface 105 and a bottom surface 107, a release coating 110, a resealable adhesive portion 115, an adhesive coating 120, and a top ply 130 having a front side 135 and a back side 137.

Base ply 100 is preferably any commercially available web-like film material that is capable of use in both an in-mold manufacturing process, and an in-line printing and converting process (as will be further described relative to manufacture of label 10). Such a film may be, for example, polypropylene. As used herein, “web-like film material” denotes any suitable label material, including paper, film, polypropylene, polyethylene, polyester, polyvinylchloride, polystyrene, foil, and ethylene vinyl acetate.

Top surface 105 of base ply 100 is capable of bearing printed graphics thereon, as indicated in FIG. 1 by reference character X.

In construction of label 10, and with particular reference to FIG. 2, release coating 110 is applied to a selected portion of top surface 105 of base ply 100. Adhesive coating 120 is applied, in turn, over selected portions of top surface 105 of base ply 100 and over release coating 110. It is to be appreciated that release coating 110, although depicted in FIG. 2 as having been applied to only a rightmost portion (reference character R) of top surface 105 of base ply 100, may be, if desired for ease of application, applied to all but a leftmost portion (reference character L) of top surface 105 of base ply 100 occupied by adhesive coating 120.

Coatings 110 and 120 are preferably chosen from water-based, solvent-based, ultraviolet light activated, and hot melt coatings as are commercially available Craig Adhesives & Coatings Co. of Newark, N.J., and Northwest Coatings Corp. of Oak Creek, Wis. Coating 120 is particularly chosen to provide secure bonding between base ply 100 and top ply 130 at leftmost portion L of label 10, while coating 110 is chosen, with respect to and in combination with adhesive coating 120, to provide resealable adhesive portion 115 for label 10 in use, at rightmost portion R.

Front and back sides 135 and 137 of top ply 130 are also capable of bearing printed graphics thereon, as depicted by reference characters Y and Z, respectively.

Most importantly, top ply 130 is chosen to exhibit dimensional shrinking in a range from about 0% to 5%, in response to the cooling from the aforesaid typical in-mold process temperatures of about 150° to 200° F. Several materials for top ply 130 have been found to be suitable, in terms of exhibiting the desired 0-5% dimensional shrinkage, such as, for example, films having a thickness of about 4 mil. available from ExxonMobil Chemical Company of Duluth, Ga. (e.g., part no. 3-OLR-243) and from AET Films of Terre Haute, Ind. (e.g., part no. 270WMS). The 0-5% dimensional shrinking of top ply 130 substantially matches dimensional shrinking of container C (depicted in FIG. 1) having been produced in an in-mold process. Specifically, it has been discovered in development of the instant invention that a typical container C shrinks in its overall dimensions by 0-5% as it cools from the aforementioned in-mold process temperature range of 170° to 200° F. to an ambient or “room” temperature range of 70° to 80° F. The matching of 0-5% dimensional shrinking between container C and integral base ply 100, and top ply 130, results in a label 10 having a top ply which resists deformation (e.g., wrinkling or buckling).

Referring again to both FIGS. 1 and 2, it is to be particularly understood that adhesive coating 120 is applied directly to top surface 105 of base ply 100 at leftmost portion L of label 10, such that back side 137 of top ply 130 is securely adhered, preferably in a lengthwise strip, to base ply 100. Thus, a so-called “hinge” for top ply 130 about base ply 100 is formed, to facilitate opening and closing of label 10 in use, in booklet fashion. Additionally, application of adhesive coating 120 over release coating 110 at rightmost portion R of label 10 is selected to provide, in combination, resealable adhesive portion 115 for resealability of top ply 130 to base ply 100 in booklet fashion.

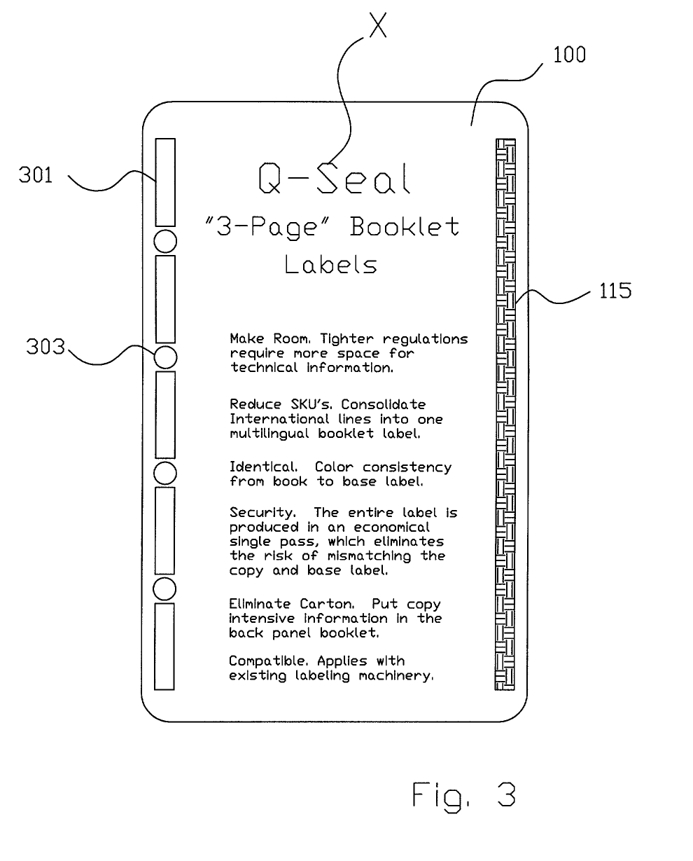

Referring to FIG. 3, there shown is a magnified illustration of components of an alternative embodiment of label 10 of the present invention. Specifically in the figure, a combination of a heat-activated adhesive coating 301 and a hot melt adhesive coating 303 is substituted for the aforedescribed adhesive coating 120 on base ply 100 at leftmost portion L in FIG. 2. It is to be understood that hot melt adhesive coating 303 is provided to securely hold base ply 100 to top ply 130 during initial stages of the in-mold process. Then, during later stages of the in-mold process, heat-activated adhesive coating 301 “activates” and becomes a bonding adhesive between base ply 100 and top ply 130 upon reaching an in-mold process temperature of about 150 to 200° F. This substitution of coatings 301 and 303 for coating 120 may be advantageous for a particular in-mold process because heat activated adhesive coating 301 will become activated while shrinking is occurring, thereby minimizing deformation.

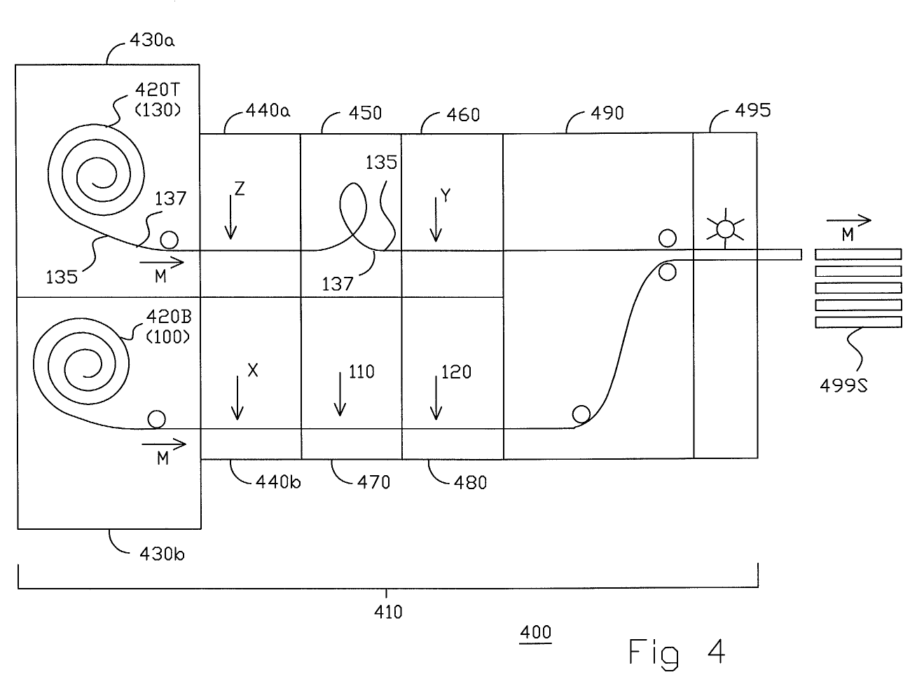

With attention, now, to FIG. 4, there depicted in schematic fashion is an exemplary in-line web press manufacturing installation 400 including multi-unit inline printing and converting press 410, for mass production of label 10.

Multi-unit press 410 of installation 400 includes an unwind units 430a and 430b, first and second printing units 440a and 440b, a web turning unit 450, a third printing unit 460, a first coating unit 470, a second coating unit 480, a nip roller web joining unit 490, and a final converting unit 495, as will now each be further described in construction of a web of labels 10.

It is to be understood that press 410 is selectively capable of providing a variable number of print stations for application and drying of pigmented inks, coatings, and adhesives. As understood by those of ordinary skill in the printing arts, the exemplary multi-unit press 410 may be any suitable narrow- or wide-web press such as a flexographic, letterpress, gravure, screen, or offset press.

Such presses are commercially available from, for example, Comco International of Milford, Ohio, or Mark Andy Inc. of St. Louis, Mo.

To begin the construction of labels 10, an unsupported film web 420T (top ply 130 in FIG. 1) is supplied in a conventional roll form to press 410 at unwind unit 430a, and in a lengthwise machine direction M thereto. Simultaneously, an unsupported film web 420B (base ply 100 in FIG. 1) is also preferably supplied in a conventional roll form to press 410 at unwind unit 430b in lengthwise machine direction M. Film webs 420T and 420B are any suitable in-line web material (e.g., the aforementioned ExxonMobil and AET Films materials).

Unwind units 430a-b pass webs 420T-B, respectively, to first printing units 440a and 440b, respectively, where printed graphics Z and X (as depicted in FIG. 1) are, respectively, printed on back side 137 of top ply 130 and on top surface 105 of base ply 100.

Web 420B bearing graphics X is then passed to first coating unit 470, where release coating 110 is selectively applied thereto (as depicted in FIG. 2 at leftmost portion L). Web 420B then passes to second coating unit 480, where adhesive coating 120 is applied thereto (also as depicted in FIG. 2).

While web 420B is being processed as aforedescribed, web 420T is simultaneously passed to web turning unit 450, where web 420T is turned over. The turning of web 420T may be provided by, for example, a turn-bar technique as is known in the art. Additionally, web 420T is then passed to third printing unit 460, where printed graphics Y (as depicted in FIG. 1) are printed on front side 135 of top ply 130.

Webs 420T and 420B then pass from units 460 and 480, respectively, to nip roller web joining unit 490. At unit 490, webs 420T-B are adhesively joined by way of adhesive coating 120. Referring also to FIG. 2, this adhesive joining of webs 420T-B forms the aforementioned secure bond between base ply 100 and top ply 130 at leftmost portion L of label 10. Adhesive coating 120 applied at rightmost portion R (FIG. 2) also provides, in combination with release coating 110, resealable adhesive portion 115 as aforedescribed.

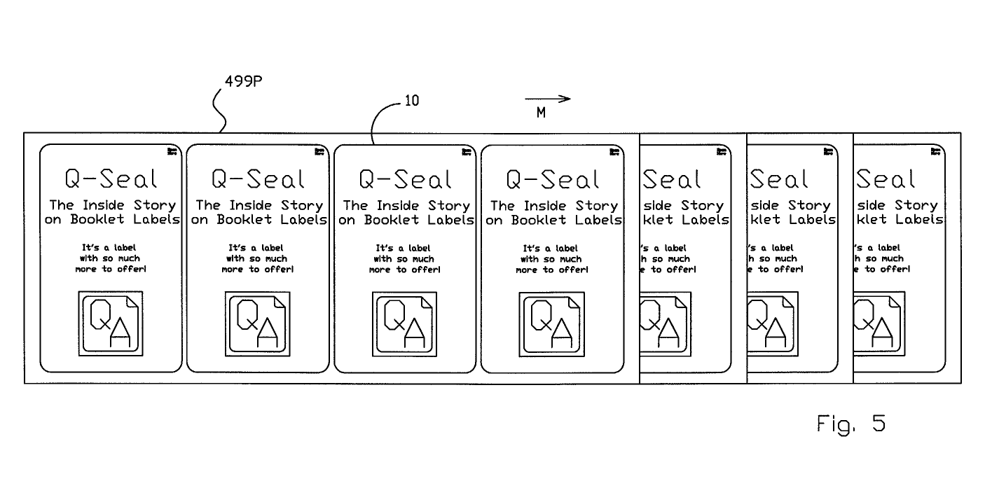

Adhesively joined webs 420T-B then pass to final converting unit 495 where die cutting or other perforation techniques may be performed to create sheeted pieces 499S carrying individual labels 10, as additionally shown in FIG. 5.

Sheeted pieces 499S may then be processed (not illustrated) by any suitable cutting/converting device (e.g., a “high die cutter” machine) for production of a stack of individually cut-out labels 10 from each piece 499S. As understood in the art, such individual labels 10 may then be loaded into a “pick-and-place” unit of an in-mold label process.

While the present invention has been particularly shown and described with reference to the accompanying figures, it will be understood, however, that other modifications thereto are of course possible, all of which are intended to be within the true spirit and scope of the present invention. It should be appreciated that components of the invention aforedescribed may be substituted for other suitable components for achieving desired similar results, or that various accessories may be added thereto.

For example, top ply 130 could comprise multiple plies, to form a multi-page booklet-type in-mold label.

Also, with reference to FIG. 2, label 10 may alternatively provide a coupon-type label. In such an embodiment, release coating 110 is provided entirely across (or “flood coated” on) base ply 100 such that top ply 130 (being a coupon) is readily removable by a consumer from base ply 100.

It is to be appreciated that any of the aforedescribed coatings and graphics may be selectively provided in any suitable combination on label 10, for a particular use thereof. For example, back side 137 of top ply 130 could receive coatings 110 and 120 thereon (as described relative to top surface 105 of base ply 100).

It is to be understood that any suitable alternatives may be employed to provide the deformation-resistant in-mold label of the present invention, along with its manufacturing scheme.

Lastly, the choice, of course, of compositions, sizes, and strengths of various aforementioned components of deformation-resistant in-mold label 10 are all a matter of design choice depending upon intended uses of the present invention.

Accordingly, these and other various changes or modifications in form and detail of the present invention may also be made therein, again without departing from the true spirit and scope of the invention as defined by the appended claims.

What is claimed is:

1. A deformation-resistant in-mold label for use in an in-mold label process, comprising:
a base ply having a top surface and a bottom surface, said base ply being adaptable for use in an in-mold labeling process, and said top surface being capable of bearing printed graphics thereon;
at least one top ply having a front side and a back side adjacent to said base ply;
a release coating applied over a selected portion of a selected one of (i) said top surface of said base ply and (ii) said back side of said top ply; and
an adhesive coating applied over (a) at least one selected portion of said release coating, and (b) a selected portion of a selected one of (i) said top surface of said base ply and (ii) said back side of said at least one top ply adjacent to said base ply, such that said top ply and said base ply are adhesively joined thereby,
wherein said at least one top ply exhibits dimensional shrinking, in response to in-mold label process temperatures, in a range from 0% to 5%.

2. The label of claim 1, wherein said base ply and said top ply are selected from the group consisting of paper, film, polypropylene, polyethylene, polyester, polyvinylchloride, polystyrene, foil, and ethylene vinyl acetate.

3. The label of claim 1, wherein said release coating is selected from the group consisting of a water-based coating, a solvent-based coating, an ultraviolet light activated coating, or a hot melt coating.

4. The label of claim 1, wherein said adhesive coating is selected from the group consisting of a water-based coating, a solvent-based coating, an ultraviolet light activated coating, and a hot melt coating.

5. The label of claim 1, wherein said adhesive coating comprises a combination of a heat-activated adhesive coating and a hot melt coating.

6. The label of claim 5, wherein said combination of a heat-activated adhesive coating and a hot melt coating are selected from the group consisting of a water-based coating, a solvent-based coating, an ultraviolet light activated coating, and a hot melt coating.

7. A deformation-resistant in-mold label for use in an in-mold label process, comprising:
a base ply having a top surface and a bottom surface, said base ply being adaptable for use in an in-mold labeling process, and said top surface being capable of bearing printed graphics thereon;
at least one top ply having a front side and a back side adjacent to said base ply;
a release coating applied in flood coat fashion over a selected one of (i) said top surface of said base ply and (ii) said back side of said at least one top ply adjacent to said base ply; and
an adhesive coating applied over at least one selected portion of said release coating, such that said at least one top ply and said base ply are removably joined by said adhesive coating in combination with said release coating applied in flood coat fashion,
wherein said at least one top ply exhibits dimensional shrinking, in response to in-mold label process temperatures, in a range from 0% to 5%.

8. The label of claim 7, wherein said base ply and said top ply are selected from the group consisting of paper, film, polypropylene, polyethylene, polyester, polyvinylchloride, polystyrene, foil, and ethylene vinyl acetate.

9. The label of claim 7, wherein said release coating is selected from the group consisting of a water-based coating, a solvent-based coating, an ultraviolet light activated coating, or a hot melt coating.

10. The label of claim 7, wherein said adhesive coating is selected from the group consisting of a water-based coating, a solvent-based coating, an ultraviolet light activated coating, and a hot melt coating.

11. A method of manufacture of deformation-resistant in-mold labels, comprising the steps of:
providing a first web material including a top ply having a front side and a back side;
providing a second web material including a base ply having a top surface and a bottom surface;
selectively printing (i) first printed graphics on said back side of said top ply, and (ii) second printed graphics on said top surface of said base ply;
selectively applying to said base ply (i) a release coating, and (ii) an adhesive coating;
selectively printing third printed graphics on said front side of said top ply; and
adhesively joining said first web and said second web.

12. The method of claim 11, further comprising the steps of:
forming individual labels in said adhesively joined first and second webs; and
cutting said adhesively joined first and second webs into individual sheeted pieces carrying said individual labels.
